(19) United States
(12) Patent Application Publication
(10) Pub. No.: US 2016/0265204 A1
(43) Pub. Date: Sep. 15, 2016

(54) APPARATUS FOR CAPTURING AND REMOVING HAIR FROM A DRAIN

(71) Applicant: Rosario Zito, Carmel, CA (US)

(72) Inventor: Rosario Zito, Carmel, CA (US)

(21) Appl. No.: 15/162,901

(22) Filed: May 24, 2016

Related U.S. Application Data
(62) Division of application No. 14/103,663, filed on Dec. 11, 2013.
(60) Provisional application No. 61/737,696, filed on Dec. 14, 2012.

(51) Int. Cl. E03C 1/264; A46B 9/02; B08B 9/027

(52) U.S. Cl. CPC E03C 1/264; B08B 9/027; A46B 9/025

(57) ABSTRACT

An apparatus for capturing and removing hair from a drain. The invention further relates to the same apparatus that can be utilized for the maintenance of drains by capturing other foreign debris for removal from a sink drain. Other embodiments of the invention are also useful for preventing drains, such as shower drains, lavatories, and the like from being clogged with foreign matter; namely hair.

### CROSS-REFERENCE TO RELATED APPLICATION

This application is a divisional application, claiming priority to co-pending U.S. patent application Ser. No. 14/103,663, filed Dec. 11, 2013, which claims priority to Provisional Patent Application No.61/737,696, An Apparatus For Capturing and Removing Flair From A Drain, filed on Dec. 14, 2012.

### FIELD OF THE INVENTION

The present invention is generally related to plumbing fixtures, particularly, an apparatus for capturing and removing hair from a drain.

### BACKGROUND OF THE INVENTION

Perhaps one of the biggest problems that people face with maintaining residential buildings is that of preventing drains, such as showers drains, lavatories, and the like from being clogged with foreign matter, namely hair. Due to the tendency of hair gradually accumulating in drains and the fact that it is very slow to deteriorate, it is a primary cause of drains clogging up in plumbing systems. If the clogged area is close to an accessible opening then the clogged system can typically be fixed with the application of plumbing tools or plumbing supplies such as abrasive chemical solutions. If the clogged area occurs in a remote position the plumbing system then the task of unplugging the drain can be very difficult, time consuming and costly to the owner of the building.

As hair slowly builds up in a drain, it can cause other debris to be clogged in the plumbing system as well. In view of this problem, the present invention provides not only a new apparatus for capturing and removing hair from a drain but also an apparatus that can be utilized for facilitating the maintenance of drains by permitting other foreign debris to be captured and removed from a drain.

The approaches used in the prior art do not present an optimal system or apparatus for trapping and removing hair from a drain pipe. Solutions that employ basket-like structures that are not positioned at a predetermined acute angle along a longitudinal shaft member may be circumvented if the basket-like structure becomes clogged with hair or other debris. When this problem occurs, hair and other debris can manage to slide along the side walls of a drain pipe causing hair to eventually become clogged in a remote area of the plumbing system. Furthermore, solutions that employ hair trapping elements that are not located in strategically positioned vertical columns along a longitudinal shaft member can cause the hair capturing device to be unsanitary and very difficult to clean.

In light of the shortcomings in the prior art, a system arid apparatus for capturing and removing hair is desired that employs a system that has hair trapping elements positioned at a predetermined acute angle in strategically placed vertical columns along a longitudinal shaft member for effectively capturing and removing hair from a drain before the hair enters into the drain pipe eventually clogging the plumbing system. The ideal system will be easy to remove from a drain pipe, can be disposable, or if not disposable, easy to clean based on the unique design of the apparatus.

### SUMMARY OF THE INVENTION

The present invention provides a new apparatus for capturing and removing hair from a drain that has novel features for capturing and removing hair from a drain which is not anticipated, rendered obvious, suggested, or even implied by any prior art drain cleaning devices, either alone or in any combination thereof. Other inventions have been implemented to capture and remove hair from a drain, but they do not include hair capturing elements disposed at or near the sink drain and that are positioned at a predetermined acute angle like the current invention includes. Nor do these other inventions include hair capturing elements that have barrier-like knobs to stop hair from flowing along the sidewalls of a drain pipe. Moreover, these other inventions further do not include a system for removing hair from a hair capturing device that utilizes a v-shaped blade device that includes a handle.

The present invention also provides a new apparatus for capturing and removing hair from a drain which may be easily and efficiently manufactured and marketed.

The present invention is a new apparatus for capturing and removing hair from a drain which is of a durable and reliable construction.

An even further feature of the present invention is to provide a new apparatus for removing hair from a drain which is susceptible of a low cost of manufacture with regard to both materials and labor, and which accordingly is then susceptible of low prices of sale to the consuming public, thereby making such apparatus for removing hair from a drain economically available to the buying public.

Still yet another feature of the present invention is to provide a new apparatus for capturing and removing hair from a drain for facilitating the maintenance of drains by permitting convenient foreign debris removal and cleaning of a drain without the need of special tools.

Still yet a further feature of the present invention is to provide a new apparatus for removing hair from a drain that provides an economical convenient apparatus for capturing and removing hair and other debris from a drain without the need to reach otherwise difficult areas of a sewer system in a manner which permits disposal of the hair and debris into the trash and then reuse of the apparatus.

Even still another feature of the present invention is to provide a new apparatus for capturing and removing hair from a drain that may be positioned in a location easily accessible at a sink, shower or tub drain.

Accordingly, for a better understanding of the present invention, its functional advantages and the specific objects attained by its uses, reference should be made to the accompanying drawings, claims and descriptive matter in which there are illustrated preferred embodiments of the invention.

### BRIEF DESCRIPTION OF THE DRAWINGS

FIG. 1 is a perspective view of one embodiment of the invention showing the apparatus for capturing and removing hair from a drain.

FIG. 2 is a side view of one embodiment of the invention showing the apparatus for capturing and removing hair from a drain.

FIG. 3 is an opposing side view of the embodiment of FIG. 2.

FIG. 4 is a front view of another embodiment of the invention showing the longitudinal shaft member secured to an integral guide that can be secured by a fastener.

FIG. 5 is a front view of another embodiment of the invention showing the longitudinal shaft member secured to a u-shaped integral guide that is not secured by a fastener.

FIG. 6 is a side view of another embodiment of the invention showing that the central longitudinal shaft member includes relatively thin like plates in which the apparatus is used for capturing and removing hair from a drain.

FIG. 7 is an opposing side view of the embodiment of FIG. 6.

FIG. 8 is a front view of another embodiment of the invention showing that the longitudinal shaft member includes relatively thin like plates secured to an integral guide that can be secured by a fastener in which the apparatus is used for capturing and removing hair from a drain.

FIG. 9 is a front view of another embodiment of the invention showing that the longitudinal shaft member includes relatively thin like plates secured to a u-shaped integral guide that is not secured by a fastener in which the apparatus is used for capturing and removing hair from a drain.

FIG. 10 is a perspective of another embodiment of the invention that can be used in a shower to capture and remove hair from a drain.

FIG. 11 is a front view of the embodiment of FIG. 10.

FIG. 12 is a top view of one embodiment of FIG. 10.

FIG. 13 is a front view of a v-shaped blade device consisting of a longitudinal-extended handle that is coupled to a syncline-shaped hook that extends from an arm used for removing hair from the hair capturing apparatus of the present invention.

FIG. 14 provides a perspective view illustrating the use of the blade device of FIG. 13 for removing hair from the hair capturing device of FIG. 1 after it has been removed from a sink, shower or tub.

FIG. 15 provides another perspective view illustrating the use of the blade device of FIG. 13 for removing hair from the hair capturing device of FIG. 6 after it has been removed from a sink, shower or tub drain.

FIG. 16 provides a further perspective view illustrating the use of the blade device of FIG. 13 for removing hair from the hair capturing device of FIG. 10 after it has been removed from a shower drain.

### DETAILED DESCRIPTION OF THE INVENTION

The following detailed description is of the best currently contemplated modes of carrying out various embodiments of the invention. The description is not to be taken in a limiting sense, but is made for at least the purpose of illustrating the general principles of the invention, since the scope of the invention is best defined by the appended claims.

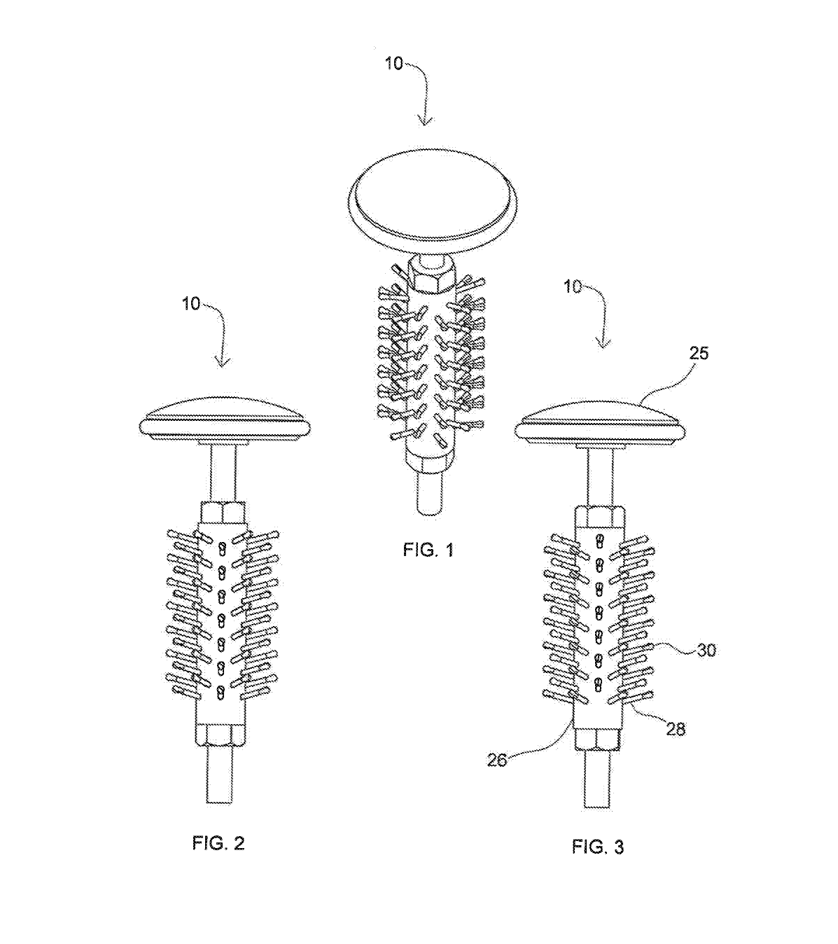

FIGS. 1 through 3 illustrate an embodiment of the present invention for capturing and removing hair from a sink. The hair capturing device 10 includes trap elements 28 that are positioned at a predetermined acute angle as to prevent hair from becoming lodged into some remote and inaccessible location in a drain pipe. The hair capturing device 10 is also positioned within the drain pipe having a downwardly extending central longitudinal shaft member 26. The upper end of the central longitudinal shaft member 26 is secured to a top member means 25 which is configured to engage a portion of a sink plate at the opening thereof so that water drains from the sink or the like and is then carried away in the building plumbing system,

Attached to and extending from the central longitudinal shaft member 26 are a plurality of slender rod-like bristles 28 of hair catching members. The bristle rod-like members 28 are spaced apart from each other a distance so as to effectively impede and entrap hair contained in water passing between them. Each of the bristle members 28 are slender rod-like elements, whether round, square or otherwise in a cross-sectional configuration. In the preferred embodiment of the invention, the outer ends of the bristle rod-like members 28 consist of barrier-like knobs 30 for effectively preventing captured hair from sliding up and then off said bristle rod-like members 28 as water containing hair passes along said bristle rod-like members 28. The outer ends of the bristle rod-like members 28 containing barrier-like knobs will further prevent hair and other debris from flowing freely along the sidewalls of a drain pipe as water containing hair passes through the drain pipe.

As shown in FIGS. 1 through 3, the preferred embodiment of the bristle rod-like members 28 are positioned on the longitudinal shaft member 26 in vertical columns extending from said shaft member 26. The bristle rod-like members can also be positioned on the longitudinal shaft member in alternative configurations other than in vertical columns so long as the alternative configurations are effective for capturing hair from a drain. In all embodiments, hair will be captured by the angled bristle rod-like members 28 as water passes downwardly in a. vertical path along the angled bristle members 28. In the preferred embodiment, the bristle rod-like members 28 extend from the exterior of the longitudinal shaft member 26 at a predetermined acute angle relative to the central radius point of the longitudinal shaft member 26, but said bristle rod-like members do not always have to pass through or be angled toward the central radius point of the longitudinal shaft member 26 so long as the alternative configurations are effective for capturing hair from a drain. The predetermined acute angle of said bristle rod-like members 28 causes the captured hair to slide or fall towards the longitudinal shaft member 26 preventing hair from being dislodged into the drain pipe.

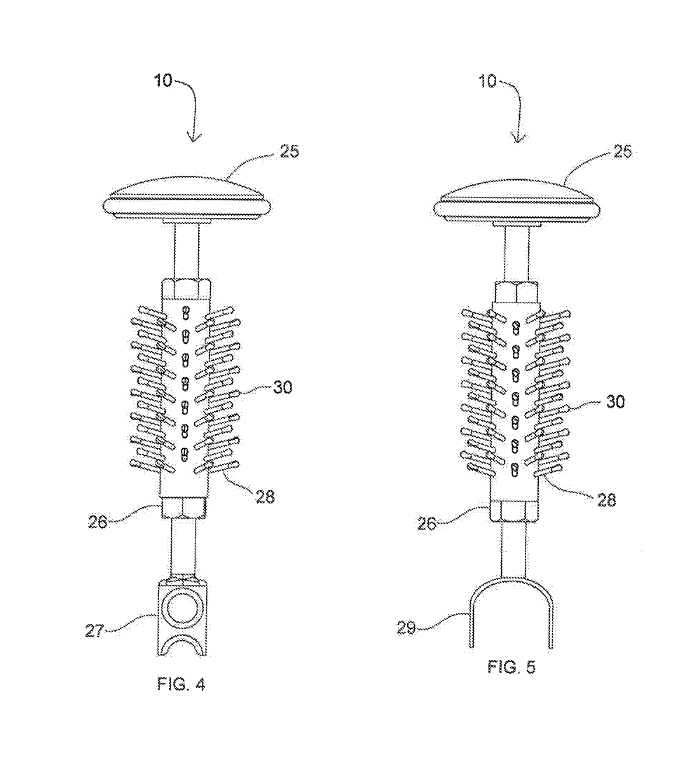

FIG. 4 shows that the bottom end of the central longitudinal shaft member 26 is secured to an integral guide 27 that can be bolted down by a fastener. A stopper actuator rod engages the integral guide that allows a user to raise or lower the hair capturing device to either entrap water within the lavatory, or permit it to drain out. FIG. 5 shows the preferred embodiment of the hair capturing device 10 where the bottom end of the longitudinal shaft member 26 is secured to a u-shaped integral integral guide 29 that does not have to be bolted down to a fastener. As in FIG. 4, a stopper actuator rod engages the integral guide 29 that also allows a user to raise or lower the hair capturing device to either entrap water within the lavatory, or permit it to drain out. In alternative embodiments, different integral guide designs can be used for raising or lowering the hair capturing device when the integral guide is engaged by a stopper actuator rod.

With the arrangement of FIGS. 1 through 5 hair capturing device 10 can be easily removed by pulling upwardly on the top member 25. Hair capturing device 10 may then be cleaned by cutting the trapped hair from the bristle members 28 with a v-shaped blade device 20 which includes a handle 32. If the hair capturing device is inexpensively made, (it can be formed of molded plastic) it can be conveniently discarded and replaced. This maintenance procedure if conducted routinely will serve to capture hair and other debris which might ultimately collect and clog a plumbing system in some remote and inaccessible area.

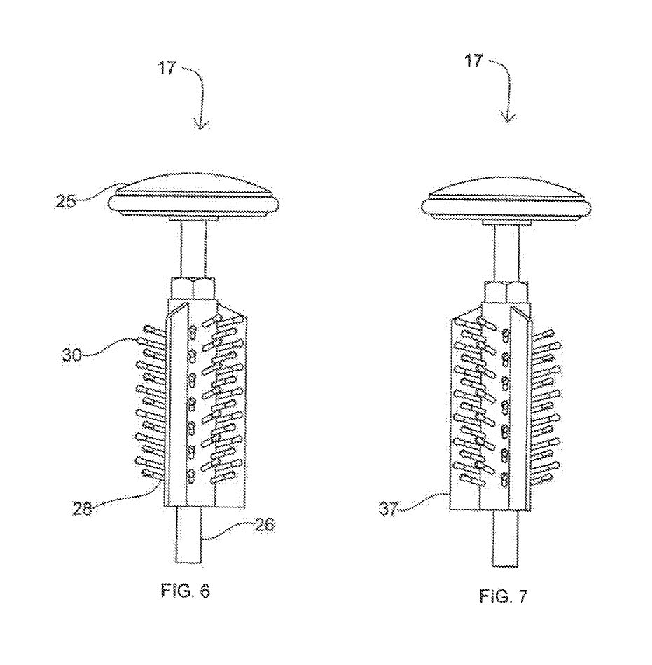

FIGS. 6 and 7 show another embodiment of the invention. In this embodiment, the longitudinal shaft member 26 of the hair capturing device 17 includes relatively thin blade-like plates 37 with a width that is less than the diameter of the drain pipe in which it is to be positioned. Within the thin plates 37 of the preferred embodiment are bristle rod-like members 28 extending from the exterior of the longitudinal shaft member 26 at a predetermined, acute angle relative to the central radius point of the longitudinal shaft member 26, but said bristle rod-like members do not always have to pass through or be angled toward the central radius point of the longitudinal shaft member 26 so long as the alternative configurations are effective for capturing hair from a drain. As in the other embodiments, hair is captured by the bristle rod-like members 28 as water passes downwardly in a vertical path along the angled bristle members 28. The predetermined acute angle of said bristle members 28 causes the captured hair to slide or fall towards the longitudinal shaft member 26 preventing hair from being dislodged into the drain pipe.

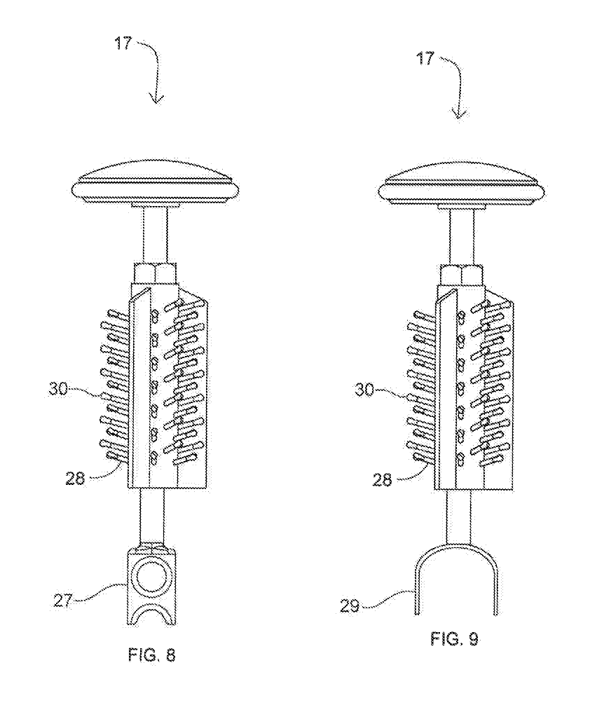

FIG. 8 shows that the bottom end of the central longitudinal shaft member 26 is secured to an integral guide 27 that is secured to a fastener. Alternatively, FIG. 9 shows that the bottom end of the central longitudinal shaft member 26 can be secured to a u-shaped integral guide 29 that does not have to be bolted down by a fastener. As in the other embodiments, a stopper actuator rod engages the integral guide that allows a user to raise or lower the hair capturing device to either entrap water within the lavatory, or permit it to drain out. In alternative embodiments, integral guides of various designs can be used for raising or lowering the hair capturing device when the integral guide is engaged by a stopper actuator rod.

With the arrangement of FIGS. 6 through 9 hair capturing device 17 can be easily cleaned by pulling upwardly on the top member 25. Hair capturing device 17 may then be cleaned by cutting the trapped hair from the bristle members 28 with a v-shaped blade device 20. If the hair capturing device is inexpensively made, (it can be formed of molded plastic) it can be conveniently discarded and replaced. This maintenance procedure if conducted routinely will serve to capture hair and other debris which might ultimately collect and clog a plumbing system in some remote and inaccessible area.

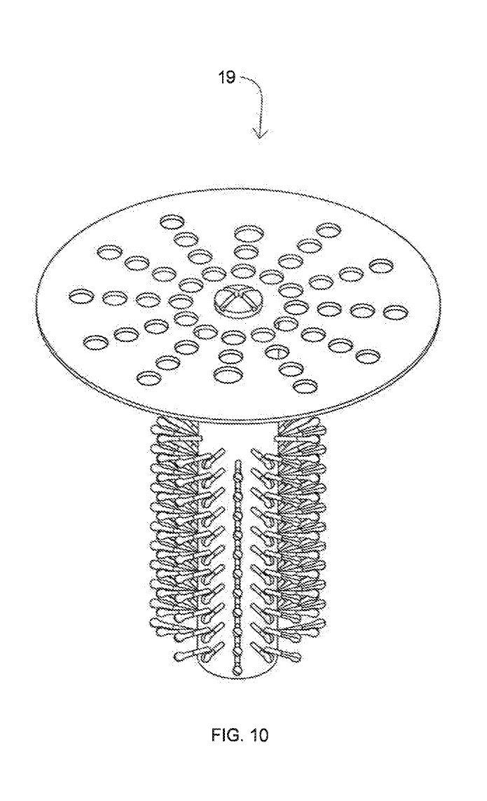

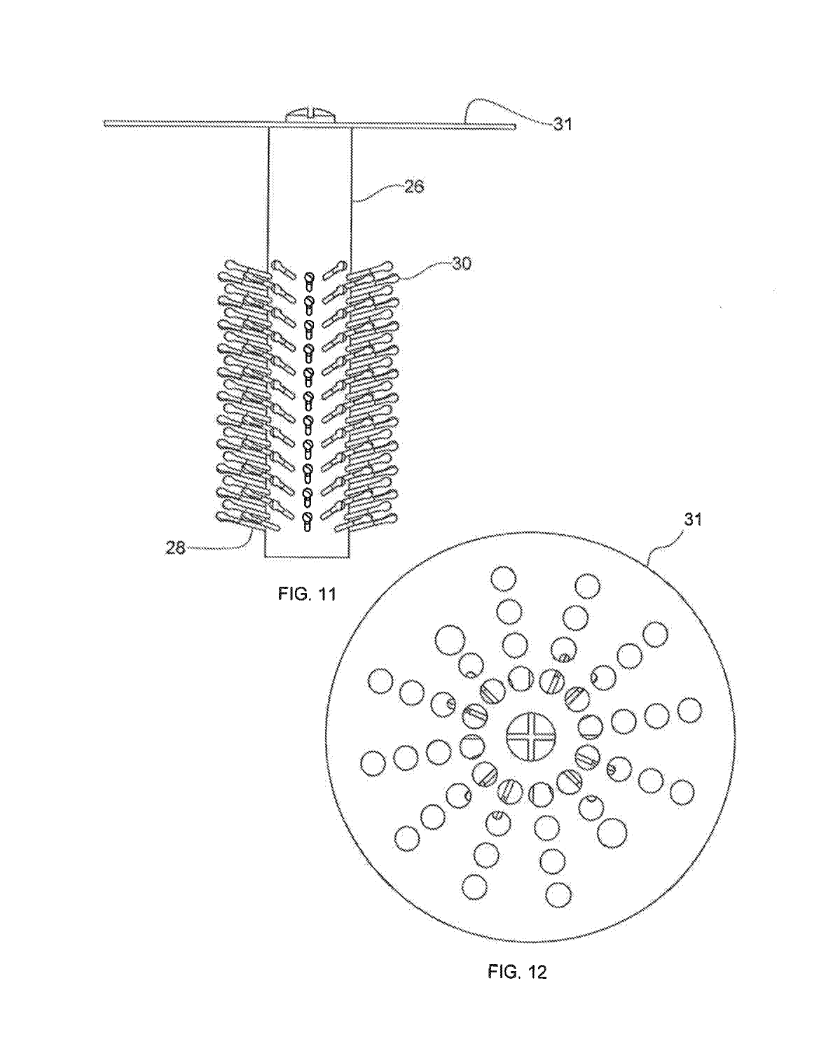

FIG. 10 shows the preferred embodiment of the hair capturing device 19 that can be used in a shower to capture and remove hair from a drain. As shown in FIG. 11, the preferred embodiment of the invention includes bristle rod-like members 28 extending from the exterior of the longitudinal shaft member 26 at a predetermined acute angle relative to the central radius point of the longitudinal shaft member 26, but said bristle rod-like members do not always have to pass through or be angled toward the central radius point of the longitudinal shaft member 26 so long as the alternative configurations are effective for capturing hair from a drain. The predetermined acute angle of said bristle rod-like members 28 causes the captured hair to slide or fall towards the longitudinal shaft member 26 preventing hair from being dislodged into the drain pipe. The upper end of the central longitudinal shaft member 26 is secured to a top end such as a drain plate 31 by means of a screw that fastens the drain plate to the upper end of the central longitudinal shaft member which is configured to engage a portion of a floor plate at the opening of a shower so that water drains from the shower or the like (such as a bathtub) and is carried away in the building plumbing system. The hair capturing device 19 is also positioned within the drain pipe having a downwardly extending central longitudinal shaft member 26.

The bristle rod-like members 28 are spaced apart from each other a distance so as to effectively impede and entrap hair contained in water passing between them. Each of the bristle members 28 are slender rod-like elements, whether round, square or otherwise in a cross-sectional configuration. The outer ends of the bristle rod-like members 28 consist of barrier-like knobs 30 for effectively preventing captured hair from sliding up and then off said bristle rod-like members 28 as water containing hair passes along the bristle members 28. The outer ends of the bristle rod-like members 28 containing barrier-like knobs further prevents hair from flowing freely along the sidewalls of a drain pipe as water containing hair passes through the drain pipe.

With the arrangements of FIG. 10 through 12 hair capturing device 19 can be easily removed by pulling upwardly on the drain plate 31. Hair capturing device 19 may then be cleaned by cutting the trapped hair from the bristle members 28 with a v-shaped blade device 20. If the hair capturing device is inexpensively made, (it can be formed of molded plastic) it can be conveniently discarded and replaced. This maintenance procedure if conducted routinely will serve to capture hair and other debris which might ultimately collect and clog a plumbing system in some remote and inaccessible area.

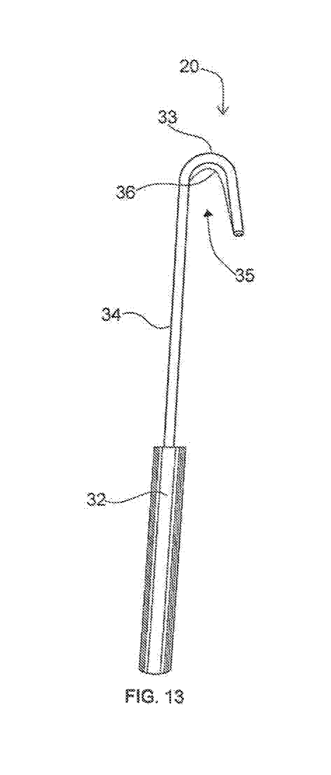

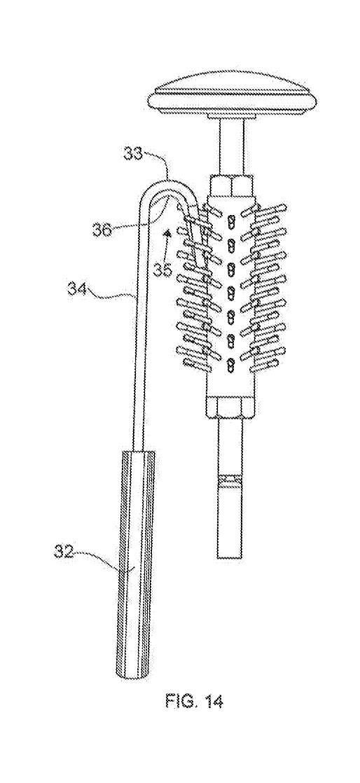

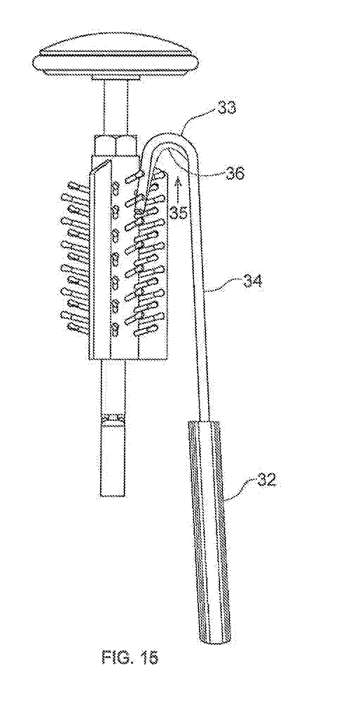

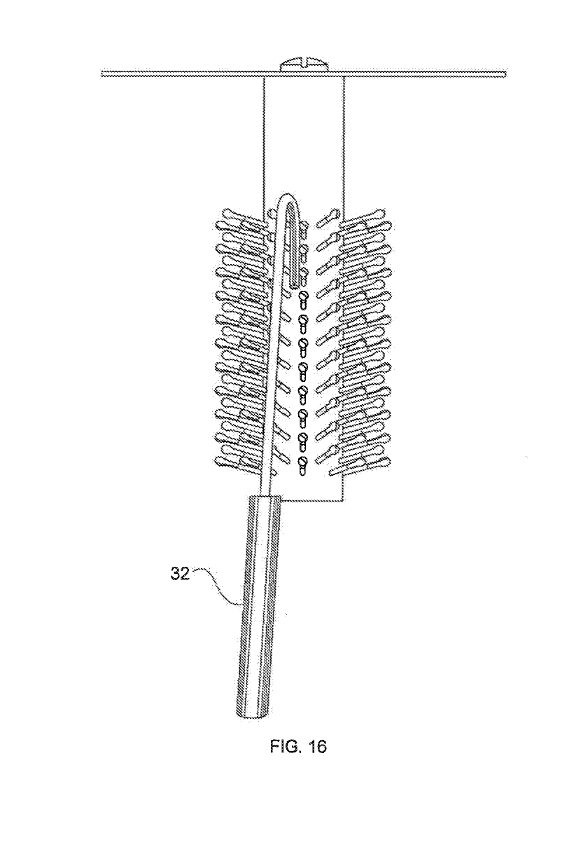

FIGS. 14 through 16 and the following discussion provide a brief, general description of a suitable hair capturing device and a v-shaped blade device 20 in which a system can be implemented for effectively removing hair and debris from the hair capturing device. FIG. 13 shows that the v-shaped blade device 20 will consist of a longitudinal-extended handle 32 that is coupled to a syncline-shaped hook 33 that extends from an arm 34. Within the syncline-shaped hook 33 is a v-shaped opening 35 that will include a blade 36 extending from the inner tip to the bottom portion thereof

FIGS. 14 through 16 also provide a perspective view showing that the hair capturing device can be easily cleaned after it has been removed from the drain pipe by positioning the outer tip of the v-shaped blade device 20 at the top of the longitudinal shaft member 26. After the v-shaped blade device 20 has been positioned, the preferred method for removing hair from the hair capturing device is to slowly slide the v-blade device 20 in a downward motion between the vertical columns of the hair catchers having slender rod-like bristles. After hair and debris has been removed from one of the vertical columns of the hair capturing device, the hair and debris can then be easily discarded into the trash and then the user of the v-blade device 20 can continue cleaning each remaining vertical column of the hair capturing device. Once all hair and debris has been removed from the hair capturing device, it can be easily placed back into the drain pipe for capturing and removing hair again from the drain pipe system.

It should be understood that the foregoing relates to exemplary embodiments of the invention and that modifications may be made without departing from the spirit and scope of the invention. It should also be understood that the present invention is not limited to the designs mentioned in this application and the equivalent designs in this description, but it is also intended. to cover other equivalents now known to those skilled in the art, or those equivalents which may become known to those skilled in the art in the future.

### INDUSTRIAL APPLICABILITY

The invention pertains to an apparatus for capturing and removing hair from a sink drain, which may be of value or importance to various industries such as, but not limited to, the plumbing and/or bathroom industry.

What is claimed is:

1. An apparatus for capturing and removing hair from a drain, comprising:
a downwardly central longitudinal shaft member having an upper end connected to a top member which is secured in place in the drain by a sink plate located at the drain opening of the sink;
a plurality of hair catchers having bristles configured substantially in the shape of slender rods, each bristle having a first end emanating from the central longitudinal shaft member, a second outer end engaging with or in close proximity to the internal circumference of a drain pipe, and positioned at a predetermined acute angle relative to the downwardly vertical flow of water in the drain for capturing hair from the drain pipe.

2. The apparatus of claim 1, Wherein the bristles extend from the exterior of the longitudinal shaft member at a predetermined acute angle relative to the central radius point of the longitudinal shaft member, but said bristles do not always have to pass through or have to be angled toward the central radius point of the longitudinal shaft member so long as the alternative configurations are effective for capturing hair from a drain.

3. The apparatus of claim 1, wherein the outer ends of the hair catchers include barrier knobs for preventing hair from sliding off the hair catching members, and for effectively preventing hair from sliding along the sidewall of the drain pipe.

4. The apparatus of claim 1, wherein the bristles are round, square or otherwise in a cross-sectional configuration.

5. The apparatus of claim 1, wherein the bristles are positioned on the longitudinal shaft member in vertical columns.

6. The apparatus of claim 1, wherein the bristles extending from the central longitudinal shaft member are positioned at a predetermined acute angle for capturing debris in the drain pipe.
